(19) United States
(12) Patent Application Publication
(10) Pub. No.: US 2025/0154917 A1
(43) Pub. Date: May 15, 2025

(54) ABNORMALITY DIAGNOSTIC DEVICE FOR INTERNAL COMBUSTION ENGINE

(71) Applicant: TOYOTA JIDOSHA KABUSHIKI KAISHA, Toyota-shi (JP)

(72) Inventors: Yoshifumi MATSUDA, Toyota-shi (JP); Akihiro KATAYAMA, Toyota-shi (JP); Kenichiro KUMADA, Nagakute-shi (JP)

(73) Assignee: TOYOTA JIDOSHA KABUSHIKI KAISHA, Toyota-shi (JP)

(21) Appl. No.: 18/899,377

(22) Filed: Sep. 27, 2024

(30) Foreign Application Priority Data
Nov. 10, 2023 (JP) 2023-192460

(51) Int. Cl. F02D 41/22

(52) U.S. Cl. CPC F02D 41/22

(57) ABSTRACT

An abnormality diagnostic device for an internal combustion engine, comprising: a reference value setting unit that determines a reference value for a pressure in a passage connected to an intake passage of an internal combustion engine; an accumulating unit that acquires a cumulative value by accumulating a difference between the reference value and the pressure from a point in time when the pressure falls below the reference value; and a diagnostic unit that diagnoses an abnormality in the passage based on the cumulative value wherein the reference value setting unit sets the reference value to a pressure after a predetermined period from a time point when the internal combustion decelerates.

### CROSS-REFERENCE TO RELATED APPLICATION

This application claims priority to Japanese Patent Application No. 2023-192460 filed on Nov. 10, 2023, incorporated herein by reference in its entirety.

### BACKGROUND

### 1. Technical Field

The disclosure relates to abnormality diagnostic devices for internal combustion engines.

### 2. Description of Related Art

There are cases where blowby gas leaks from a combustion chamber into a crankcase of an internal combustion engine. The blowby gas flows through a blowby gas passage and is recirculated to an intake passage. A technique of detecting an abnormality of a blowby gas passage based on the pressure in the blowby gas passage has been developed (e.g., Japanese Unexamined Patent Application Publication No. 2020-186702 (JP 2020-186702 A)).

### SUMMARY

However, diagnosis accuracy may decrease due to behavior of the pressure. It is therefore an object to provide an abnormality diagnostic device for an internal combustion engine that can improve diagnosis accuracy.

The above object can be achieved by an abnormality diagnostic device for an internal combustion engine that includes: a reference value setting unit that sets a reference value for a pressure in a passage connected to an intake passage of an internal combustion engine; an accumulating unit that acquires a cumulative value by accumulating a difference between the reference value and the pressure from a time point when the pressure falls below the reference value; and a diagnostic unit that diagnoses an abnormality of the passage based on the cumulative value. The reference value setting unit sets the reference value to a pressure after a predetermined period from a time point when the internal combustion engine decelerates.

The reference value setting unit may set the reference value to a pressure after the predetermined period from a time point when a decrease in an amount of air in the intake passage becomes equal to or greater than a predetermined amount.

The abnormality diagnostic device may further include a period setting unit that sets the predetermined period based on the decrease in the amount of air. When the decrease in the amount of air is equal to or greater than the predetermined amount at a first time point and the decrease in the amount of air is equal to or greater than the predetermined amount at a second time point later than the first time point, the period setting unit may set a first period that is the predetermined period for the first time point, and may set a second period that is the predetermined period for the second time point. The reference value setting unit may set the reference value to a pressure at a time point when either the first period or the second period, whichever ends later, has elapsed.

When the decrease in the amount of air in the intake passage is less than the predetermined amount, the reference value setting unit may set the reference value to a pressure at a time point when the amount of air is increasing.

When the cumulative value is equal to or greater than a predetermined value, the diagnostic unit may diagnose that the passage is normal. When the cumulative value is less than the predetermined value, the diagnostic unit may diagnose that the passage is abnormal.

It is thus possible to provide an abnormality diagnostic device for an internal combustion engine that can improve diagnosis accuracy.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an internal combustion engine and an abnormality diagnostic device;

FIG. 2 is a flowchart illustrating a process according to the embodiment;

FIG. 3 is a flowchart illustrating a process according to the embodiment;

FIG. 4A is a diagram illustrating a time chart according to the embodiment;

FIG. 4B is a diagram illustrating a time chart according to the embodiment;

FIG. 4C is a diagram illustrating a time chart according to the embodiment;

FIG. 5A is a diagram illustrating a time chart according to the embodiment;

FIG. 5B is a diagram illustrating a time chart according to the embodiment;

FIG. 5C is a diagram illustrating a time chart according to the embodiment;

FIG. 5D is a diagram illustrating a time chart according to the embodiment;

FIG. 6A is a diagram illustrating a time chart according to a comparative example; and

FIG. 6B is a diagram illustrating a time chart according to a comparative example.

### DETAILED DESCRIPTION OF EMBODIMENTS

Hereinafter, an abnormality diagnostic device for an internal combustion engine according to an embodiment of the present disclosure will be described with reference to the drawings. However, in the drawings, the dimensions, ratios, and the like of the respective parts may not be shown so as to completely coincide with the actual ones. Further, in some drawings, details are omitted.

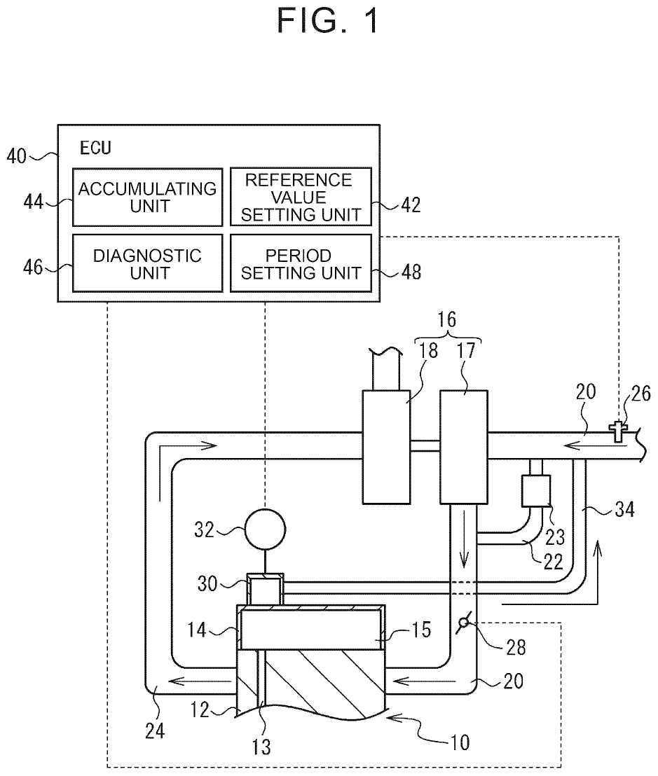

FIG. 1 is a schematic diagram illustrating an internal combustion engine 10 and an abnormality diagnostic device. Electronic Control Unit (ECU) 40 functions as an abnormality diagnostic device. The abnormality diagnostic device is applied to the internal combustion engine 10.

The internal combustion engine 10 is, for example, a gasoline engine, and burns fuel to generate a driving force. The internal combustion engine has a cylinder head 12 and a head cover 14, and also has a cylinder block and a crankcase (not shown). The cylinder head 12 is attached to a cylinder block. The head cover 14 covers the cylinder head 12. An intake passage 20 and an exhaust passage 24 are connected to the cylinder head 12.

A crankshaft is accommodated in the crankcase. The piston is connected to the crankshaft via a connecting rod. A combustion chamber is defined in the cylinder head 12. Air flowing through the intake passage is introduced into the combustion chamber. Fuel is injected from a fuel injection valve (not shown). When the air-fuel mixture is combusted in the combustion chamber, the piston reciprocates, and the crankshaft rotates. The exhaust gas generated in the combustion is discharged to the exhaust passage 24.

An air flow meter 26, a compressor 17, and a throttle valve 28 are arranged in this order from the upstream side in the intake passage 20. The air flow meter 26 detects a flow rate (amount of air) of the air flowing through the intake passage 20. The throttle valve 28 regulates the amount of air. The larger the opening degree of the throttle valve 28 is, the more the amount of air increases. The smaller the opening degree, the more the amount of air decreases. A turbine 18 is provided in the exhaust passage 24.

The compressor 17 and the turbine 18 are connected to form a supercharger 16. The exhaust gas flowing through the exhaust passage 24 is blown to the turbine 18, and the turbine 18 rotates. The compressor 17 rotates with the turbine 18. The compressor 17 supercharges the air in the intake passage 20. By introducing high-pressure air into the internal combustion engine 10, the output of the internal combustion engine 10 is improved.

A bypass passage 22 is connected between the upstream side and the downstream side of the compressor 17 in the intake passage 20. A bypass valve 23 is provided in the middle of the bypass passage 22. By opening the bypass valve 23, air flows to the internal combustion engine 10 bypassing the compressor 17. When the bypass valve 23 is closed, a larger amount of air flows into the compressor 17 and is supercharged.

The space 15 is defined by the head cover 14 and the cylinder head 12 of the internal combustion engine 10. The passage 13 is provided in the cylinder head 12 and the cylinder block, and extends from the space 15 to the inside of the crankcase. Blow-by gas leaking from the combustion chamber to the crankcase passes through the passage 13 and is accumulated in the space 15.

The joint 30 is attached to the head cover 14. One end of the blow-by gas passage 34 is connected to the joint 30, and the other end is connected to a position upstream of the compressor 17 of the intake passage 20. The blow-by gas in the space 15 flows through the blow-by gas passage 34, returns to the intake passage 20, and is supplied to the internal combustion engine 10 together with the air. The pressure sensor 32 detects the pressure in the blow-by gas passage 34.

When the throttle valve 28 is opened, air flows into the internal combustion engine 10. The pressure in the intake passage 20 decreases to a negative pressure lower than the atmospheric pressure. The blow-by gas flows from the space 15 into the low-pressure intake passage 20. When the blow-by gas flows, the pressure in the blow-by gas passage 34 also becomes low, e.g., lower than atmospheric pressure. As the amount of air in the intake passage 20 decreases, the pressure in the blow-by gas passage 34 increases. When an abnormality occurs in the blow-by gas passage 34, the pressure in the blow-by gas passage 34 is less likely to change. For example, if the blow-by gas passage 34 is dislodged and if the blow-by gas passage 34 is damaged, the blow-by gas passage 34 is opened to the atmosphere. Therefore, the pressure is equivalent to the atmospheric pressure.

ECU 40 is an abnormality diagnostic device, and includes an arithmetic device such as Central Processing Unit (CPU), Random Access Memory (RAM), and a storage device such as Read Only Memory (ROM). ECU 40 performs various types of control by executing programs stored in a ROM or a storage device. ECU 40 acquires the pressure detected by the pressure sensor 32 and the amount of air detected by the air flow meter 26. ECU 40 controls the opening degree of the bypass valve 23 and the opening degree of the throttle valve 28.

ECU 40 functions as a reference value setting unit 42, an accumulating unit 44, a diagnostic unit 46, and a period setting unit 48. The reference value setting unit 42 sets a reference value with respect to the pressure in the blow-by gas passage 34. The accumulating unit 44 accumulates the difference between the pressure and the reference value when the pressure is lower than the reference value. When the pressure is higher than the reference value, the accumulating unit 44 does not perform the accumulation. The diagnostic unit 46 diagnoses the blow-by gas passage 34 based on the cumulative value and determines that it is normal or abnormal. The period setting unit 48 sets a period until the reference value setting unit 42 determines the reference value of the pressure.

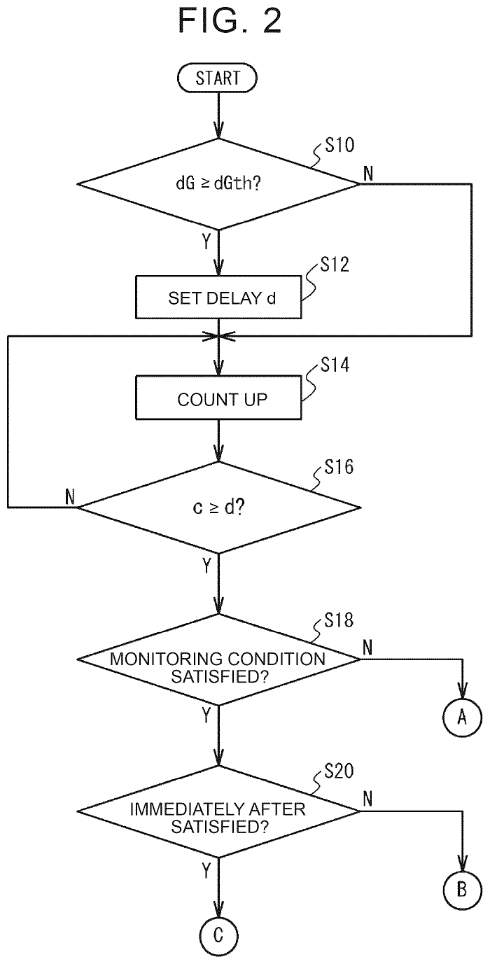

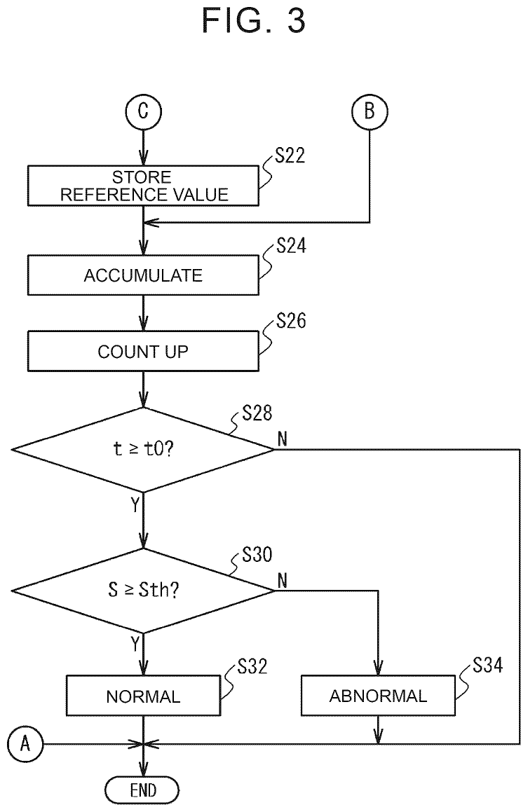

FIG. 2 and FIG. 3 are flowcharts illustrating processing according to the embodiment. ECU 40 acquires the amount of air from the air flow meter 26, and calculates a decrease dG in amount of air at regular intervals (for example, every 160 milliseconds). The period setting unit 48 determines whether the decrease dG from the amount of air 160 milliseconds (ms) before is equal to or greater than the predetermined amount dGth (S10). dGth is, for example,-8 g/s. When YES (Yes), the period setting unit 48 sets the delay d (predetermined period) (S12). When NO in S10 (No), the period setting unit 48 regards the delay d as zero. After S12 or when NO in S10, ECU 40 counts up (S14).

ECU 40 determines whether the count c is greater than or equal to the delay d (S16). When NO, counting is continued (S14). When YES, ECU 40 determines whether or not the pressure-monitoring condition is satisfied (S18). The monitoring condition is determined by the state of the internal combustion engine 10, and may be determined, for example, by the amount of air. As an example, the monitoring condition may be satisfied when the amount of air shifts from decreasing to increasing. When NO in S18 (No), the process ends. When YES (Yes), ECU 40 determines whether it is immediately after the monitoring condition is satisfied (S20). For example, the determination result is YES when the elapsed time from the establishment of the monitoring condition is several ms or less.

As shown in FIG. 3, the reference value setting unit 42 stores a reference value of the pressure (S22). When the delay d is set to a value other than 0, the pressure at the time of elapse of the delay d becomes the reference value. If d=0, the pressure when the monitoring condition is satisfied becomes the reference value.

When NO in S20 or after S22, the accumulating unit 44 accumulates the difference between the reference value of the pressure and the pressure detected by the pressure sensor 32, and calculates the cumulative value S (S24). The accumulating unit 44 also counts up the period of accumulation (S26). The accumulating unit 44 determines whether or not the accumulation time t has reached a predetermined time t0 or more (S28). When NO, the process ends. When YES, the diagnostic unit 46 determines whether the cumulative value S is equal to or greater than a predetermined value Sth (S30). When the cumulative value S is equal to or larger than Sth (when YES), the diagnostic unit 46 diagnoses that the blow-by gas passage 34 is normal (S32). When the cumulative value S is less than Sth (when NO), the diagnostic unit 46 diagnoses that the blow-by gas passage 34 is abnormal (S34). Thus, the process ends.

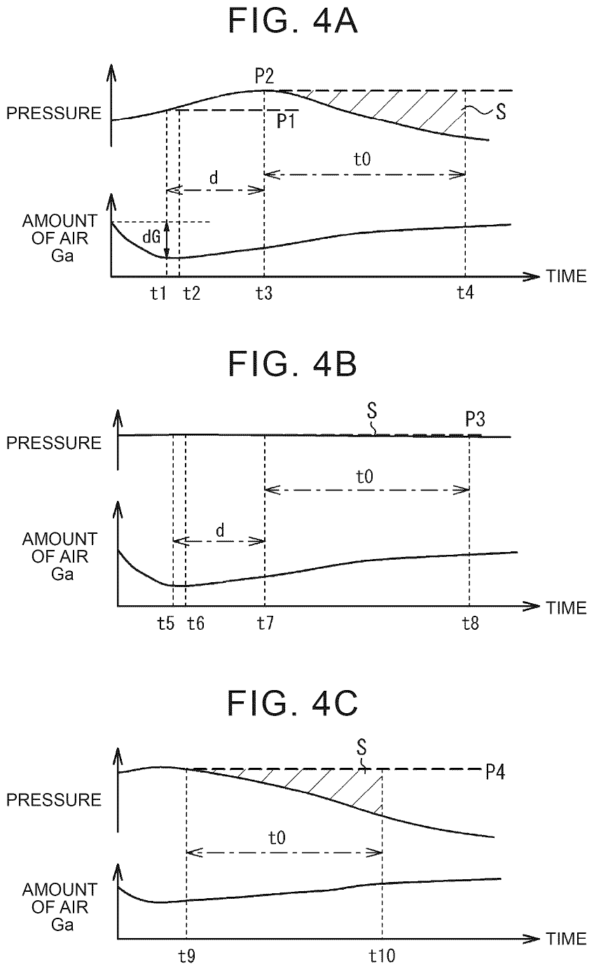

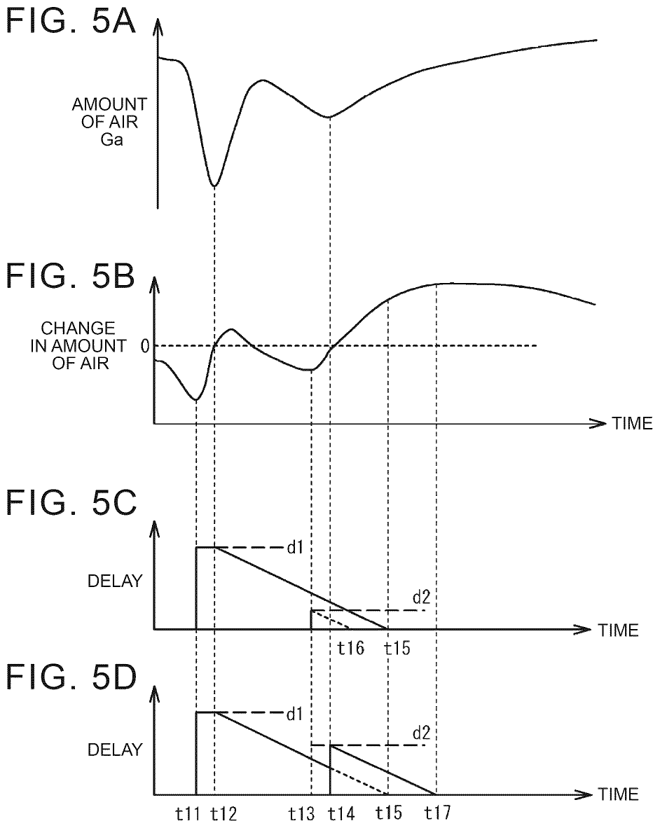

FIGS. 4A to 5D are diagrams illustrating time charts according to the embodiment. In each of FIGS. 4A to 4C, the upper row represents the pressure in the blow-by gas passage 34. The lower row represents the amount of air Ga flowing through the intake passage 20. In each figure, a hatched portion is an accumulated range.

FIG. 4A shows an example where the blow-by gas passage 34 is normal and the internal combustion engine 10 decelerates significantly. When the vehicle equipped with the internal combustion engine 10 decelerates, the internal combustion engine 10 reduces the amount of air to be sucked and decelerates. ECU 40 calculates, for example, a difference dG between the amount of air 160 ms before and the current amount of air. In response to the deceleration of the internal combustion engine 10, dG becomes equal to or higher than dGth (for example,-8 g/s) at time t1. The period setting unit 48 sets the delay d (S12). The delay d is longer as the absolute value of a change dG in amount of air is larger, and shorter as the absolute value is smaller. For example, counting of the delay d is started at time t1 (S14). The amount of air shifts from decreasing to increasing at around time t2 (S18 in FIG. 2). The pressure at time t2 is P1. At time t3 later than time t2, the count c reaches a delay d. The reference value setting unit 42 sets the reference value to the pressure P2 in the time t3 (S22).

The pressure responds later than the change in amount of air Ga, and the pressure P2 at time t3 that is higher than P1. After the time t3, the pressure is below P2. The accumulating unit 44 accumulates the difference between the reference pressure P2 and the pressure during the period from the time t3 to the time t4, and calculates the cumulative value S (S24). The period (period from t3 to t4) t0 during which the accumulation is performed is, for example, 400 ms.

FIG. 4B shows an example where the blow-by gas passage 34 is abnormal and the internal combustion engine 10 is greatly decelerated. Delay d is set to the time t5. The delay d elapses in t7, and the reference value P3 is set. Although the amount of air is increasing at time t6, the blow-by gas passage 34 is dislodged, so that the air pressure is kept close to the atmospheric pressure. The reference value P3 is also comparable to atmospheric pressure. The accumulating unit 44 accumulates the difference between the reference value P3 and the pressure during the period from the time t7 to t8.

In FIG. 4A, the pressure in the blow-by gas passage 34 decreases as the amount of air in the intake passage 20 increases. The cumulative value S becomes larger, and becomes equal to or larger than the threshold Sth. The diagnostic unit 46 diagnoses as normal (S32). In FIG. 4B, for example, the blow-by gas passage 34 is removed. Regardless of the amount of air, the pressure in the blow-by gas passage 34 is maintained at the same level as the atmospheric pressure. The cumulative value S is small and less than the threshold Sth. The diagnostic unit 46 diagnoses an anomaly (S34).

FIG. 4C shows an example in which the blow-by gas passage 34 is normal, and the internal combustion engine 10 does not significantly decelerate. The change dG in amount of air is less than dGth. It is assumed that the monitoring conditions are arranged t9 the hours. The reference value setting unit 42 sets the reference value to the pressure P4 immediately after establishment (S22). The accumulating unit 44 performs accumulation from t9 to t10. The cumulative value S is greater than or equal to the threshold Sth. The diagnostic unit 46 diagnoses as normal (S32). When the change dG in amount of air is less than dGth and the blow-by gas passage 34 is abnormal, the cumulative value S is less than the threshold Sth because the pressure is near the atmospheric pressure as in the example of FIG. 4B. The diagnostic unit 46 diagnoses an anomaly (S34).

In the example of FIGS. 5A to 5D, the internal combustion engine 10 repeats deceleration and acceleration. FIG. 5A shows the amount of air Ga. FIG. 5B shows the amount of change dG in air. FIGS. 5C and 5D represent delays.

As shown in FIG. 5A, the amount of air Ga repeatedly increases and decreases according to the acceleration and deceleration of the internal combustion engine 10. At time t11 (first time), the change dG in amount of air is equal to or greater than dGth. In time t12, dG is positive. At time t13 (second time), the change dG in amount of air is again equal to or greater than dGth. dG is positive at time t14. The period setting unit 48 sets a delay d1 (first period) according to a decrease in amount of air at time t11, and sets a delay d2 (second period) according to a decrease in amount of air at time t13. The delay d1 is subtracted from time t12. The delay d2 is subtracted from time t13.

In the example of FIG. 5C, at time t14 when the delay d2 starts to be counted, the remaining time of the delay d1 is larger than the delay d2. That is, time t15 at which the delay d1 ends is later than time t16 at which the delay d2 ends. The period setting unit 48 employs a delay d1. The reference value setting unit 42 sets the reference value to the pressure at the time when the delay d1 ends.

In the example of FIG. 5D, the delay d2 is greater than the remaining time of the delay d1 at the time t14 when the delay d2 starts counting. That is, time t17 at which the delay d2 ends is later than time t15 at which the delay d1 ends. The period setting unit 48 employs a delay d2. The reference value setting unit 42 sets the reference value to the pressure at the time when the delay d2 ends.

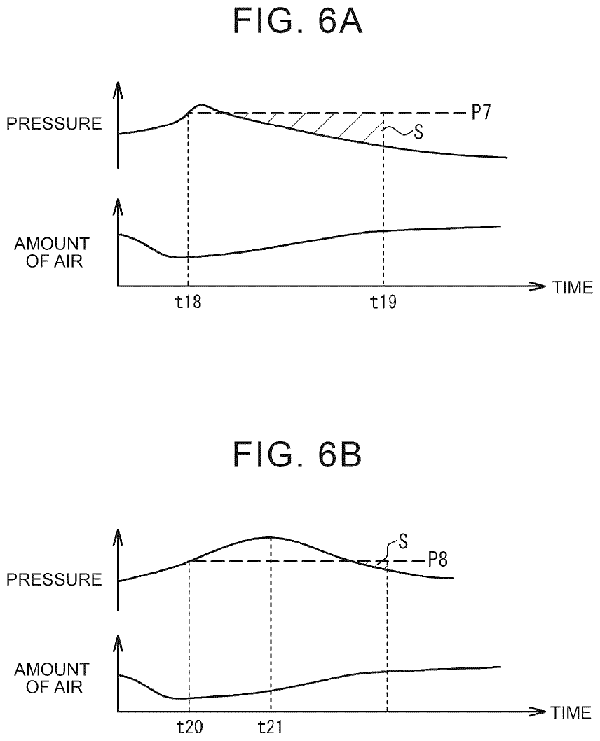

FIGS. 6A and 6B are diagrams illustrating time charts according to a comparative example. In the example of FIG. 6A, the amount of air starts to increase at time t18. The accumulation is performed from t18 to t19 using the pressure P7 at time t18 as the reference value.

In the example of FIG. 6B, the amount of air starts to increase at time t20. The pressure P8 at time t20 is used as the reference value. However, the pressure peaks at time t21 later than time t20 because the pressure response is delayed from the change in amount of air. Since the pressure near the peak is larger than the reference value P8, the accumulation is not performed. Since the cumulative value S becomes small, the accuracy of the diagnosis of normal/abnormal is deteriorated.

According to the present embodiment, as shown at time t1 in FIG. 4A, the amount of air Ga decreases as the internal combustion engine 10 decelerates. When the change dG in amount of air is equal to or larger than the threshold dGth, the period setting unit 48 sets the delay d. The reference value setting unit 42 sets the reference value to the pressure at time t3 when the delay d has elapsed from time t1. The accumulating unit 44 accumulates the difference between the reference value and the pressure. The diagnostic unit 46 performs diagnosis based on the cumulative value. The pressure is delayed in response to the deceleration of the internal combustion engine 10. When the delay d has elapsed, the pressure increases in accordance with the deceleration. Since the reference value is set to the pressure, the cumulative value S increases. Diagnostic accuracy is improved.

Since the amount of air decreases according to the deceleration of the internal combustion engine 10, the deceleration can be detected from the amount of air. For example, when the decrease dG in amount of air in the intake passage 20 becomes equal to or larger than the predetermined amount dGth, the delay d is determined. The reference value setting unit 42 sets the reference value to the pressure after the elapse of the delay d. The pressure response is delayed in response to a decrease in amount of air. Since the reference value corresponding to the delay of the response is determined, the cumulative value S increases. Diagnostic accuracy is improved. The deceleration of the internal combustion engine 10 may be detected from an index other than the amount of air, such as the vehicle speed, and the reference value may be set to the pressure at the time point when the delay d elapses from the time when the internal combustion engine is greatly decelerated.

As shown in FIG. 5B, when the decrease dG in amount of air at times t11 and t13 are equal to or greater than dGth, the period setting unit 48 sets delays d1, d2 based on the decrease dG in amount of air. The greater the absolute value of the decrease dG, the longer the corresponding delay. In the example of FIG. 5C, the delay d1 out of the delays d1, d2 ends later. The reference value setting unit 42 sets the reference value to the pressure at time t15 when the delay d1 has elapsed. In the example of FIG. 5D, the delay d2 out of the delays d1, d2 ends later. The reference value setting unit 42 sets the reference value to the pressure at time t17 when the delay d2 has elapsed. The pressure increases because it waits a longer time from deceleration. By using a high pressure as the reference value, the accuracy of diagnosis is improved.

In the example of FIG. 4C, the decrease dG in amount of air is less than dGth. The period setting unit 48 does not set the delay d. The reference value setting unit 42 sets the reference value to a pressure at a time point when the amount of air is increasing (e.g., t9). Diagnosis is possible even if the amount of air is not significantly decreased.

When the cumulative value S is equal to or larger than the threshold Sth, the diagnostic unit 46 determines that the cumulative value S is normal. When the cumulative value S is less than the threshold Sth, the diagnostic unit 46 determines that an error has occurred. The cumulative value S is determined according to whether the blow-by gas passage 34 is normal or abnormal. It is possible to perform highly accurate diagnosis based on the cumulative value S.

In an abnormal condition, such as the blow-by gas passage 34 being disengaged or the blow-by gas passage 34 being perforated, the blow-by gas passage 34 is opened to the atmosphere. As shown in FIG. 4B, the pressure is less likely to decrease with an increase in amount of air, and maintains the atmospheric pressure level. The reference value setting unit 42 sets the reference value to the pressure at the time point when the amount of air starts to increase. The reference value is about the same as the atmospheric pressure, and the pressure does not significantly change from the reference value. The cumulative value S decreases. Abnormalities can be accurately detected.

The condition for monitoring the pressure may be that the amount of air is increasing or that the amount of air is shifting from decreasing to increasing. The state of the internal combustion engine 10 may be set as a condition, and may be other than the amount of air. For example, it may be a condition that the water temperature of the coolant of the internal combustion engine 10 is equal to or higher than a predetermined temperature, and that the pressure in the intake passage 20 is equal to or lower than a predetermined value. The timing at which the subtraction of the delay is started may be a time point at which the delay is set as shown in FIG. 4A, or a time point at which the change dG in amount of air becomes positive as shown in FIGS. 5C and 5D. The period t0 during which the accumulation is performed may be longer than 400 ms or shorter than 400 ms.

In the above example, ECU 40 diagnoses the blow-by gas passage 34. In addition to the blow-by gas passage 34, embodiments may be applied to passages that are connected to the intake passage 20 and through which gas passes, such as, for example, an EGR passage.

Although the preferred embodiment of the disclosure is described above in detail, the disclosure is not limited to the specific embodiment, and various modifications and changes may be made within the scope of the disclosure described in claims.

What is claimed is:

1. An abnormality diagnostic device for an internal combustion engine, the abnormality diagnostic device comprising:
a reference value setting unit that sets a reference value for a pressure in a passage connected to an intake passage of an internal combustion engine;
an accumulating unit that acquires a cumulative value by accumulating a difference between the reference value and the pressure from a time point when the pressure falls below the reference value; and
a diagnostic unit that diagnoses an abnormality of the passage based on the cumulative value, wherein the reference value setting unit sets the reference value to a pressure after a predetermined period from a time point when the internal combustion engine decelerates.

2. The abnormality diagnostic device according to claim 1, wherein the reference value setting unit sets the reference value to a pressure after the predetermined period from a time point when a decrease in an amount of air in the intake passage becomes equal to or greater than a predetermined amount.

3. The abnormality diagnostic device according to claim 2, further comprising a period setting unit that sets the predetermined period based on the decrease in the amount of air, wherein:
when the decrease in the amount of air is equal to or greater than the predetermined amount at a first time point and the decrease in the amount of air is equal to or greater than the predetermined amount at a second time point later than the first time point, the period setting unit sets a first period that is the predetermined period for the first time point, and sets a second period that is the predetermined period for the second time point; and
the reference value setting unit sets the reference value to a pressure at a time point when either the first period or the second period, whichever ends later, has elapsed.

4. The abnormality diagnostic device according to claim 2, wherein when the decrease in the amount of air in the intake passage is less than the predetermined amount, the reference value setting unit sets the reference value to a pressure at a time point when the amount of air is increasing.

5. The abnormality diagnostic device according to claim 1, wherein:
when the cumulative value is equal to or greater than a predetermined value, the diagnostic unit diagnoses that the passage is normal; and
when the cumulative value is less than the predetermined value, the diagnostic unit diagnoses that the passage is abnormal.
